(19) United States
(12) Patent Application Publication
(10) Pub. No.: US 2011/0010264 A1
(43) Pub. Date: Jan. 13, 2011

(54) Pay To bid Auction System

(76) Inventor: Darin Mitchell Gould, Michigan City, IN (US)

Correspondence Address: Eli Weiss, Esq.;Oakwood Law Group, LLP, 14 Bond Street -- SUITE 386, Great Neck, NY, 11021, US

(21) Appl. No.: 12/832,048

(22) Filed: Jul. 7, 2010

Related U.S. Application Data
(60) Provisional application No. 61/223,536, filed on Jul. 7, 2009.

(51) Int. Cl. G06Q 30/00

(52) U.S. Cl. 705/26.3

(57) ABSTRACT

Methods and systems for conducting electronic auctions. Bidders purchase the chance to bid, the number of times bidding are used as a winning factor. Bidder who has the highest Personal Bid and earliest bid time is selected as winner. Alternatively, Bidder who spend Highest Credit Bid and earliest bid time is selected as winner.

### REFERENCE TO RELATED APPLICATIONS

This patent application claims the benefit of U.S. Provisional Application No. 61/223,536 filed on Jul. 7, 2009, the disclosure of which is incorporated herein in its entirety by reference.

### DESCRIPTION OF RELATED ART

The present application relates to electronic auction system, and more particularly to an electronic auction system wherein users pay to place a bid, and incentives are given to early bidders and frequent bidders.

Note that the points discussed below may reflect the hindsight gained from the disclosed inventions, and are not necessarily admitted to be prior art.

Online auctions are becoming popular network-based electronic commerce and, providing a sensational and efficient way for buying, selling and negotiation between buyers and sellers of goods and services on the Internet. Traditionally sellers enjoy conducting business where there are many buyers and buyers enjoy conducting business where there are many choices. However, as the online auction industry has matured, the mass market approach for many sellers has been an effort with diminishing returns as auctions inherently lead buyers' main focus to price.

Current auctions conducted by service providers, such as eBay.com, only require sellers to pay a fee for setting up an account on the service provider's system, and for sellers listing their items for auction. Bidders are not required to pay fee to set up an account. Buyers login to place a bid, and when the date and time for ending the auction arrives, the highest price bidder becomes the winner and buys the item at the final price. Often a seller may not be able to make a profit if not enough bidders participate the auction.

It is estimated that there are over 1000 companies similar to eBay, Inc. that compete by offering a variety of auction-styled ecommerce environments that address a wide range of horizontal and vertical marketplaces. No systems have thought of providing incentives for buyers to participate an auction at early stage and to place bids more often.

### SUMMARY

The present application discloses new approaches to provide incentives for bidders to participate auctions early and to place more bids.

In one embodiment, an electronic auction system includes user database that auction participants are required to set up accounts by purchasing credits or bids. The system tracks an auction participants' bidding histories, accumulated numbers of biddings and accumulated credits spent. Computation servers are instructed to decide the winners according to designated special auction rules that provides incentives for bidders to participating bidding.

In one aspect, the auction winner is the bidder who placed the highest bidding price reached within the auction time frame.

In one aspect, the auction winner is the bidder who placed the most number of bids.

In one aspect, the auction winner is the bidder who has spent the most credits during the auction.

In one embodiment, non-winning bidders are allowed to recycle their purchased bids to use in next auction.

In one embodiment, free credits are provided as promotion to induce bidding.

In another embodiments, the price of a bid varies in accordance with certain rule to provide different level of incentives to participate in the auction early.

In another embodiment, alternative items are provided for various level of bidders.

The disclosed innovations, in various embodiments, provide one or more of at least the following advantages. However, not all of these advantages result from every one of the innovations disclosed, and this list of advantages does not limit the various claimed inventions.

The system prevents the auction from losing money if it ends early, before reaching a reserve price. It maintains an incentive even if the auction should end early by providing alternate credits for winners of auctions that end early.

It advances the auction toward a successful sale, even if the auction should end early. It creates an environment where bidders can use a variety of bidding strategies.

It allows auction thousands of items, worth millions of dollars, while maintaining very low final purchase price.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 schematically shows an example functional flow chart of an auction system in accordance with this application.

FIGS. 2-7 schematically show an example functional flow chart of “Bid Placed” module in accordance with this application.

FIGS. 8-9 schematically show an example functional flow chart of “Auction Ends” module in accordance with this application.

FIG. 10 schematically show an example functional flow chart of “Test Connection” module in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

This electronic network of “pay to bid” auction system combines several elements in a unique manner to facilitate holding auctions with very high values: up to hundreds of millions or even billions of dollars.

The system includes user database, central servers and displays system that displays the user interface. The system is instructed by installed software to perform various functions disclosed in this application.

The bidders will need to purchase bids before being able to place a bid. The basic function of the Pay to Bid Auction system is as follows:

When an auction begins, a timer will begin counting down to zero. Participants purchase bids and/or set up account for credits. When a user places a bid, the Common Bid will increase by some fixed amount, and the timer will be reset to a value established in the rules for the particular auction. If none places a bid, and the timer reaches zero, then the auction will end. The winners can then purchase the items, usually at a price related to the value of the Common Bid, as established in the rules for each auction. An auction could also end if it continues up to a specific time and date established in the rules for a particular auction.

The system combines three methods of determining winners. The rules of a particular auction may use one, two, or all three methods. Preferably, auctions will use the Common Bid method together with the Personal Bid method.

A) “Common Bid”: every time any user bids in a particular auction it will increase the common bid. The latest bidder becomes the highest bidder on the Common Bid List.

B) “Personal Bid”: the number of times a particular user has bid in a particular auction. Each time a user bids it will increase their “Personal Bid” in this particular auction.

Auction rules will convert the number of times participants bid into a monetary value, which represents their “Personal Bid” and the amount they will pay to purchase an item if they win an auction. Typically, participants' number of bids will simply be multiplied by some fractional or whole part of a penny.

For example: 29 bids×1 cent each=29: Their Personal Bid would be $0.29.

The High Personal Bid List is then determined: all participants would be ranked first in the order of the value of their Personal Bid. Then, for each particular value, participants would be ranked in the order in which they placed their bid. The High Personal Bid list would then be taken in order, beginning with the Bidder with the highest Personal Bid and earliest bid time, according to the number of winners set in the auction rules.

The bidder who has purchased the most bids will be the highest bidder on the Personal Bid List.

C) “Credit Bid”: Each time a user bids it will increase their “Credit Bid” in this particular auction. This is the total number of credits a bidder has spent while bidding on a particular auction. (If the cost to bid was always the same, then the highest “Personal Bid” and highest “Credit Bid” would be the same bidder. However, this system includes an option to increase cost to bid every time a bid is placed, so there could be different highest bidders when using both these methods together on the same auction.

Typically, the monetary value of participants' Credit Bids will simply be equal to the number of credits spent.

The High Credit Bid List is then determined. All participants would be ranked first in the order of the value of their Credit Bid. Then, for each particular value, participants would be ranked in the order in which they placed their bid. The High Credit Bid list would then be taken in order, beginning with the bidder with the highest Credit Bid and earliest bid time, according to the number of winners set in the auction rules.

The bidder who has spent the most credits on bids will be the highest bidder on the Credit Bid List.

The cost of a bid, aka “Cost to Bid” in the system, can change by a fixed value, for example, increase a fixed fractions of one cent each time a bid is placed. Each time a user bids, the cost to bid will then increase for the next person to place a bid, and so on, until the auction ends.

For instance, the Cost to Bid could increase: 1/10,000, 1/100,000. or 1/1,000,000 of one cent each time a bid is placed. The fractional amount could be as small as is deemed necessary to fit the needs of a particular auction.

The Cost to Bid could increase by fractional parts of a penny every time a bid is placed, or periodically.

For example, the first bid could cost 10 credits (10 cents). The Cost to Bid could increase one-ten-thousandth of a cent each time a bid is placed.

1st bid costs $0.10.0000;

2nd bid costs $0.10.0001;

30,000th costs $0.39.9999;

30,001^{st} costs $0.40.0000.

Or the first bid could cost $0.10 and the Cost to Bid could increase one cent every ten thousand bids.

1st to 10,000th bid cost $0.10 each;

10,001st to 20,000th bid cost $0.10 each.

The system could increase the Cost to Bid according to varying periods for a particular auction. The system could increase the Cost to Bid one cent each time an increasing number of bids have been placed.

First 10 bids cost $0.10 each;

Next 11 bids cost $0.11 each;

Next 12 bids cost $0.12 each.

The cost to bid could also stay the same throughout a particular auction.

In a particular auction, the rule can be set that the Common Bid can increase by fractional parts of a penny each time a bid is placed. The Common Bid can increase at a fixed rate or at an increasing or decreasing rate.

When a particular auction begins, the Common Bid could start at any amount and each time a user places a bid, the Common Bid would increase, for example, by a fixed fractional part of a penny. The fractional amount added could be as small as 1/1,000,000 of a penny, or even smaller as required for a particular auction with high total value. For example, the Common Bid could start at $0.10.0000 and add $0.00.0001 each time a bid is placed.

The Increase of Common Bid can be at changing rate. The rate at which the Common Bid increases could increase or decrease until a minimum or maximum rate of change is reached. The rate could change by a small amount each time a bid is placed, or periodically each time a certain number of bids have been placed. The change could begin with the first bid or it could begin changing once a certain Common Bid has been reached, such as the Reserve Price.

Auction participants are also encouraged to purchase credits. Credits will facilitate purchasing bids, the price of which may include fractional parts of a penny and as small as millionths, or even smaller as required for a particular auction.

The auction can use a second decimal to indicate fractional parts of credits, for example, $0.10.0009.

“Pay to Bid” electronic auction system also includes other features as follows:

1) Reserve Price: Auctions can have a reserve price. If a particular auction ends before the Common Bid reaches the reserve price, then the featured item will not be sold. Instead, winners will have the option to purchase items of lower value.

2) Alternate Item Value: If an auction has a reserve price, then a lower valued item will be offered at the start of the auction. As the Common Bid increases, the value of the alternate item will increase. The rate the alternate value item increase will be based on some percentage of income generated by the auction (example: 50%).

3) Auction Restart: If an auction ends early, items equal to a certain percent of the credits earned from the auction would be sold to the winners. The rest of the credits will be applied to reducing the Reserve Price and the Auction will Restart. An auction can restart as many times as required until the Common Bid Reaches the Reserve Price and the Featured Items are sold to the highest bidders.

4) FreeCredits: When auctions first begin, they can offer FreeCredits as an Alternate Value Item. FreeCredits can be spent just like normal Credits, except that they can only be spent on auctions after the Reserve Price has been met, if an auction has a Reserve Price. FreeCredits do not add a cost to an auction. So, if an auction ends early, the Reserve Price will still ensure the auction generates an appropriate level of income to cover the entire cost of all items sold.

5) Winner Option to decline Alternate Value Item: When an auction ends early, before the Reserve Price is met, the rules could allow winners to decline to accept the Alternate Value Item. If a winner accepts the Item, then they will lose the Personal Bids they have accumulated and lose their place on the High Personal Bid List. So, by declining the Alternate Item, they could benefit by keeping their place on the High Personal Bid List. Optionally, the auction could then offer the item to the next ranking participant who did not already win an item.

Winners may need to decline the item before the auction restarts.

6) Multiple Item Auctions, Different Items for each Winning Method, and Winning Multiple Items in an Auction. Multiple Items can be offered for sale in an auction. An auction could have multiple winners for one or more Methods used to determine winners.

For instance, an auction could offer ten items for sale. Five items could be sold to the five highest bidders on the Common Bid List, and five items could be sold to the five highest bidders on the Personal Bid List.

A particular auction may offer different items, different numbers of items, and different valued items for sale via each Method. Furthermore, an auction could allow bidders to win more than one items. First, a single bidder could be on the highest bidder list for two methods, such as the Common Bid List, and the Personal Bid list. In this case they could win two items in a particular auction.

For any particular auction, the rules could either allow or disallow the possibility to win an auction by more than one method.

Second, a single bidder could be on the Common Bid List multiple times. The number of items a single bidder could win in such a situation would be determined in the rules for each particular auction.

7) Reusable Personal Bids (Recycled Personal Bids) and Refunded Credits (FreeCredits). Rules, for a particular auction, may allow participants who do not win to reuse Personal Bids and/or Credits, which they bought/spent on this auction. In contrast, all winners will not be refunded any Personal Bids or Credits.

For Recycled Personal Bids, when a bidder does not win a particular auction, then after the auction has closed, the rules of the auction may allow the bidder to reuse the Personal Bids they purchased in this auction in a future auction. For each Personal Bid the bidder purchased in the auction, they would receive one Recycled Personal Bid they could use in another auction.

The rules of each auction could either allow or disallow the use of Recycled Personal Bids. If an auction allows Recycled Personal Bids, each time a bidder purchases a bid, the bidder would be able to apply Recycled Personal Bids in some ratio determined by the rules of this particular auction.

For example, when the bidder places a bid, they could also choose to apply 1, 2, 5 or some other number of Recycled Personal Bids, thus increasing their total Personal Bid for this auction.

For Refunded Credits, the rules of an auction could allow credits of participants who were not winners to be refunded to them as FreeCredits. These FreeCredits could then be reused on other auctions which allow the use of FreeCredits.

8) Sale of more than one Personal Bid in a single transaction: the rules of a particular auction could allow bidders to purchase more than one Personal Bid at a time. This would be useful to bidders who want to get a higher position on the Personal Bid List.

This type of transaction would increase the Common Bid as if just a single bid were purchased, but would increase the bidder's Personal Bid by an amount equal to the number of bids they purchase.

9) Automatic Bidding System & Sniping Option: Participants would have an options to set an automatic bidding system to bid on their behalf. The user could also set up the AutoBid to attempt to snipe the auction by setting it to bid only when an auction is approaching the final time and date when the auction will end.

Users have the following options: A) Time to start bidding; B) Maximum Credits to spend; C) The number of bids (from other participants) to wait before sending another bid. This option may useful in auctions that have more than one item for auction, and each participant could win more than one item. This option could be used to attempt to increase a participants chance to win. Instead of setting the autobidder to bid as soon as another participant places a bid, a user could set the autobidder to wait every 10th bid in an auction in which 10 items will be sold to the top 10 high bidders on the Common Bid List.

The auction software could potentially need to handle thousands of bids per second. To handle bids as efficiently as possible, several versions of the software will be run on one or more servers to handle auctions using the same or similar sets of rules. Each version of the software will exclude portions of the code, which are unnecessary for auctions with particular rules.

The auction network may utilize separate version of software to manage the database and run the auction and bidding system. They could run on separate servers. This is to ensure the software runs as efficiently as possible.

In order to attempt to prevent an auction from ending early due to an Internet connection problem, the system will use one or more additional servers set up on different Internet backbones and send encrypted messages between them in order to test the Internet connection before an auction closes. In case there is a delay, the auctions could be paused until the connection problem has been resolved.

The “Pay to Bid” electronic auction system handles various currencies, for simplicity, the US Dollar is used in the examples.

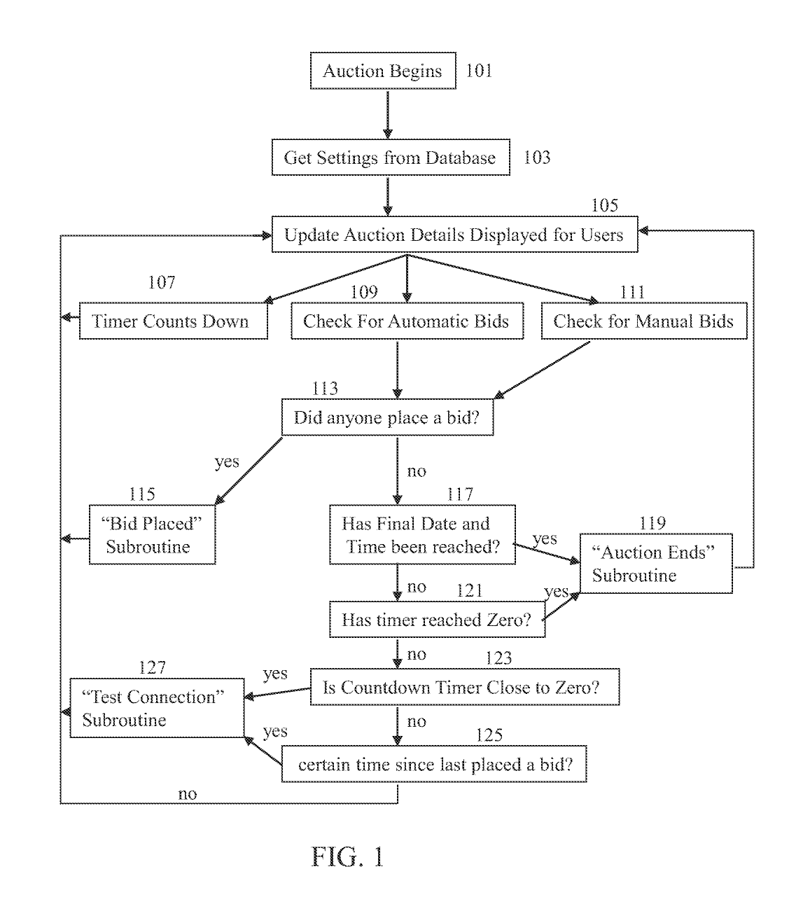

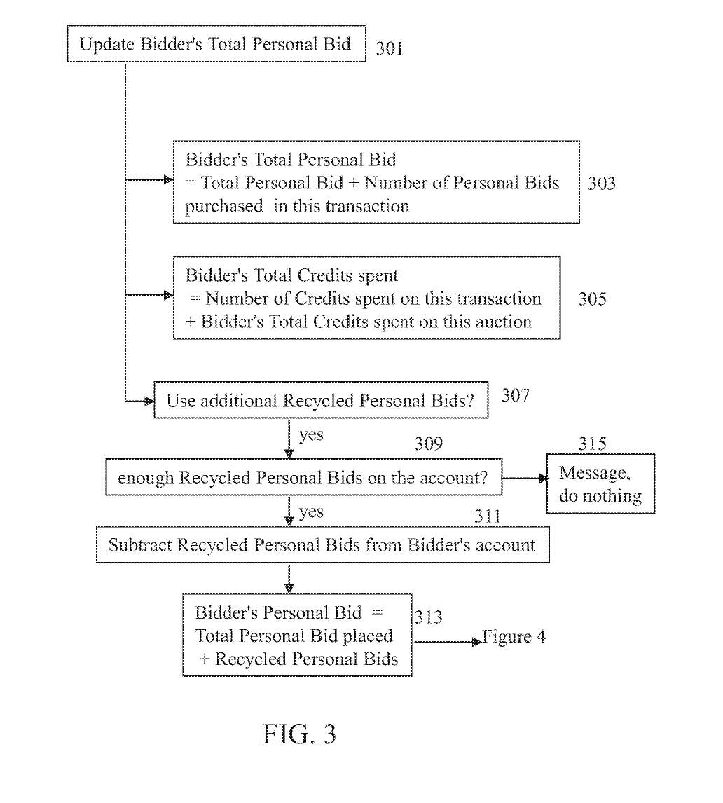

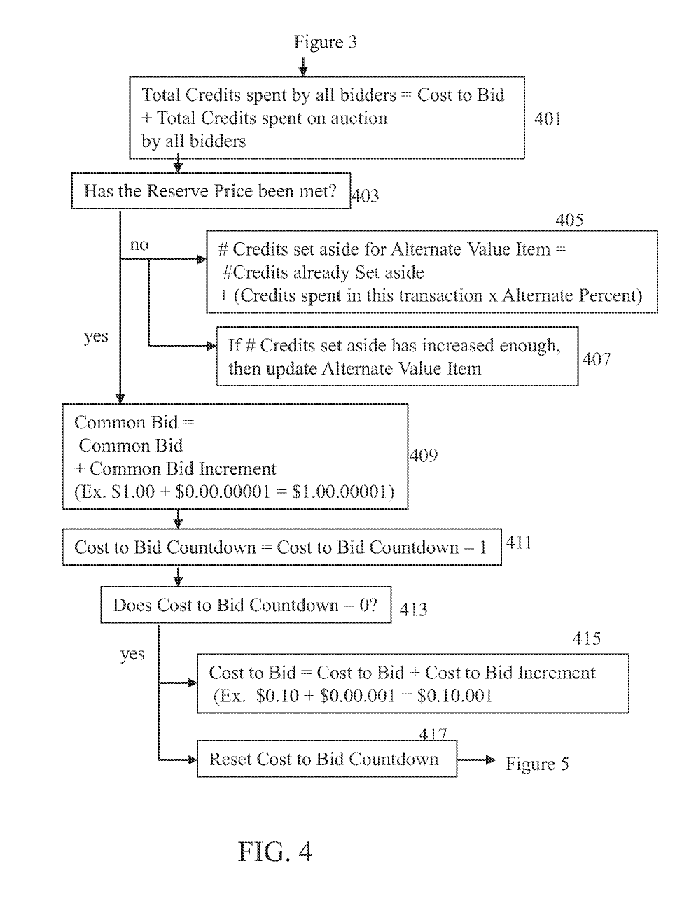

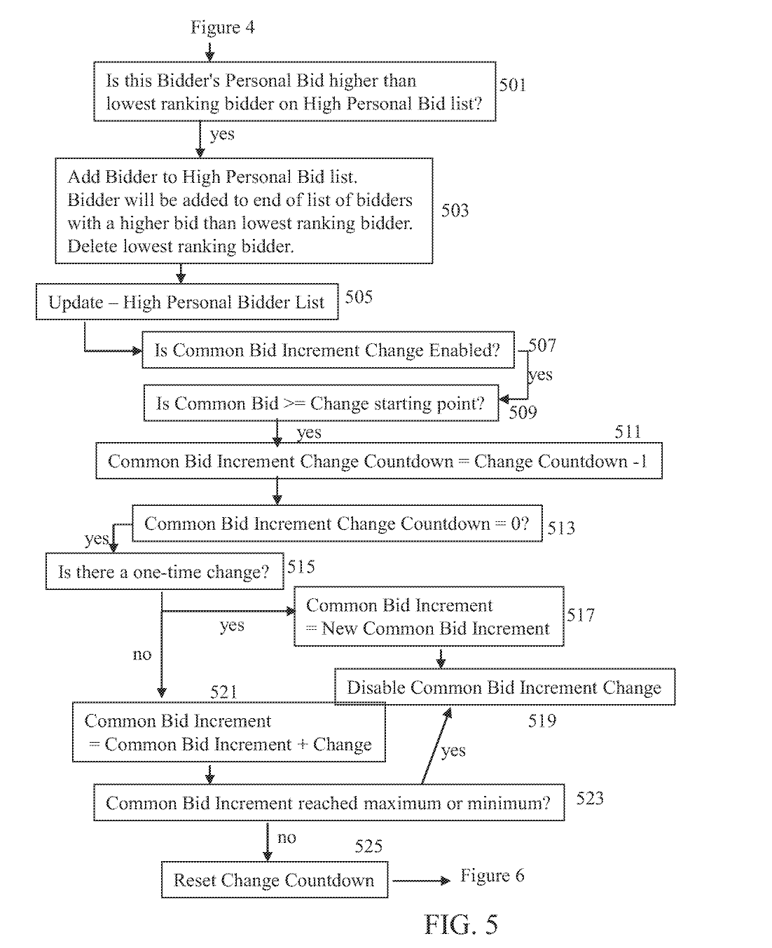

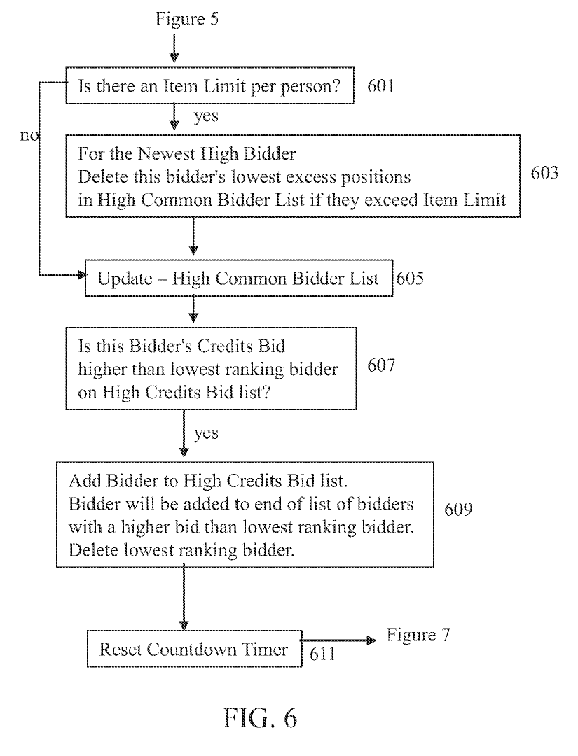

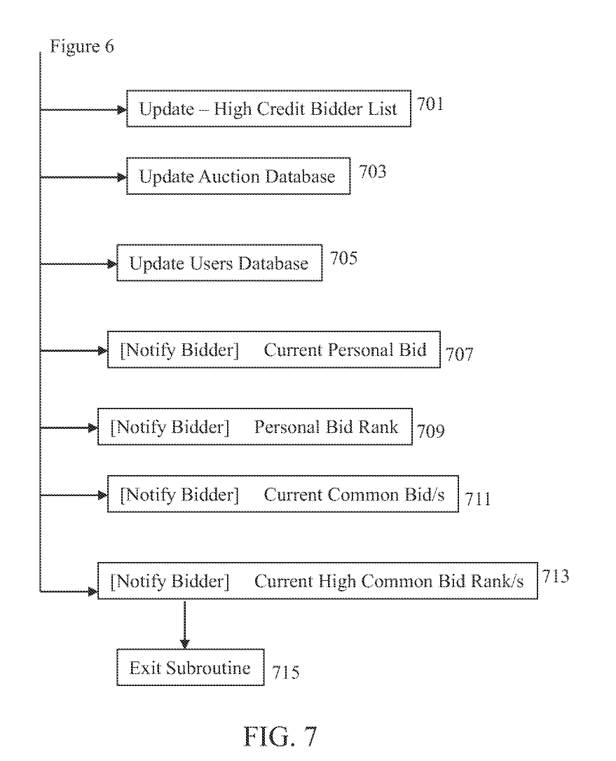

FIGS. 1 to 10 show an example logic flow chart of a “Pay to Bid” auction embodiment.

In reference to FIG. 1, the example embodiment includes a database that tracks auction participants' bidding history and account settings, shown in step 103. It has user interface for display updated auction information, as shown in step 105. It has timer module, as shown in step 107, “Bid Placed subroutine” module as shown in step 115, and “Auction Ends subroutine” module as shown in step 119, and “Test Connection subroutine” as shown in step 127.

Main properties of the system include: 1) Bids; 2) Timer; 3) Increment; 4) Price.

‘Bids’ may be sold at various rates at steps 101-105.

Quantity discounts may be offered, for example, $100 for 100 “Bids”, free bids for signing up for a new account OR for referring new customers may also be offered.

For each bid, Timer may be set to any suitable time for a particular auction, for example, 20 seconds or 3 minutes, at step 107. The Timer is reset every time a bid is placed and begins counting down again.

If none else bids and the timer reaches zero then the highest bidder has won, at step 117 and step 121.

Every time a bid is placed at step 109, 111 and 113, the Auction Price increases an increment in step 115. Auction Price is the current price of the item being auctioned. The Price may be set to begin at any relevant value by the seller. Every time a user places a bid the Price increases by the Increment.

Users can setup “BidBuddies” OR “BidButlers” to bid automatically on their behalf. To use a BidBuddy they set 1) amount they wish to begin bidding; 2) amount they wish to stop bidding; 3) maximum number of bids they want to use

Every timer a user places a Bid the Timer resets and begins counting back down to zero. Whenever the timer reaches zero the highest bidder wins. The highest bidder may be determined according to if it is the Highest Personal Bidder or the Highest Credit Spender. The winner the pays the final Common Bidding Price to buy the item (most common)—OR they pay a Fixed amount—For example $100—OR they get a full discount for the item.

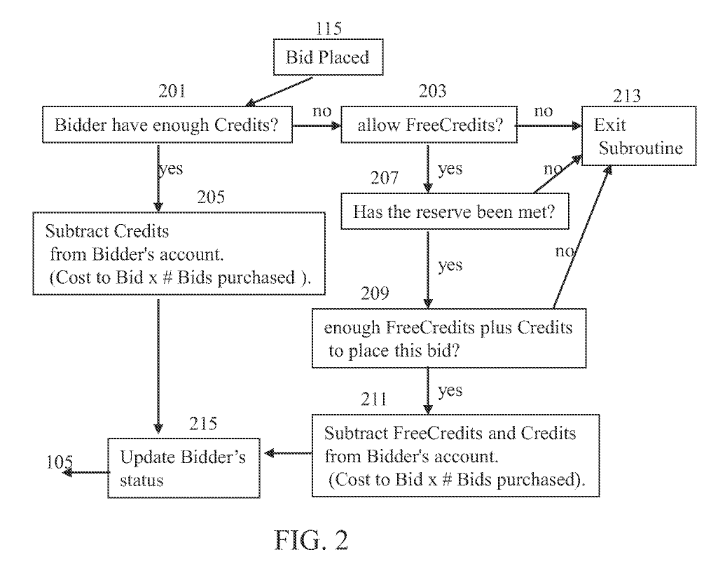

FIGS. 2-7 show a logic flow of the process to keep track of each bidder's bidding history and the accumulation of Personal Bid, and determination of High Common Bid list, High Personal Bid list, and High Credit Bid list, and updating the databases.

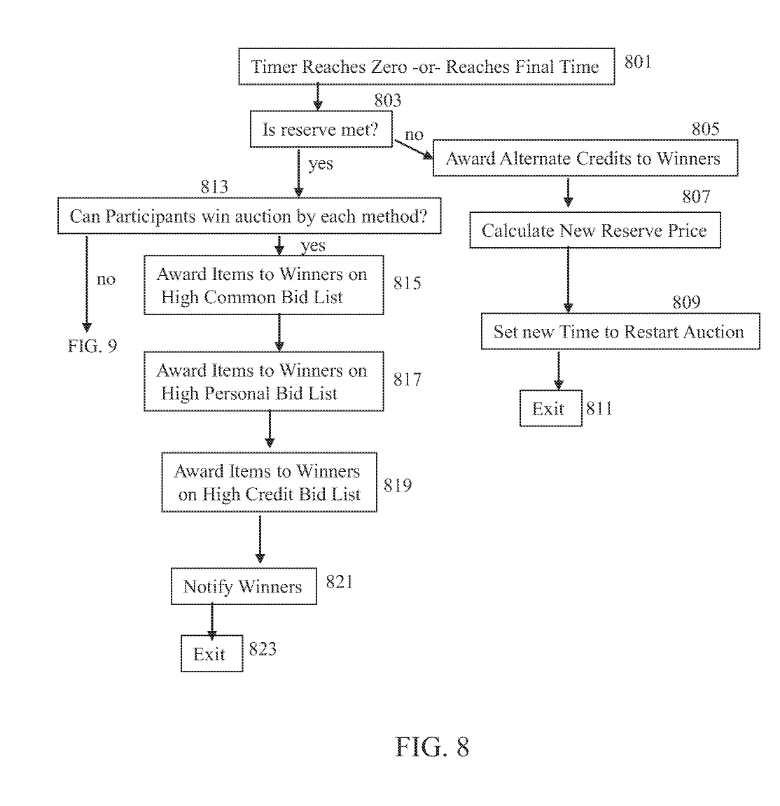

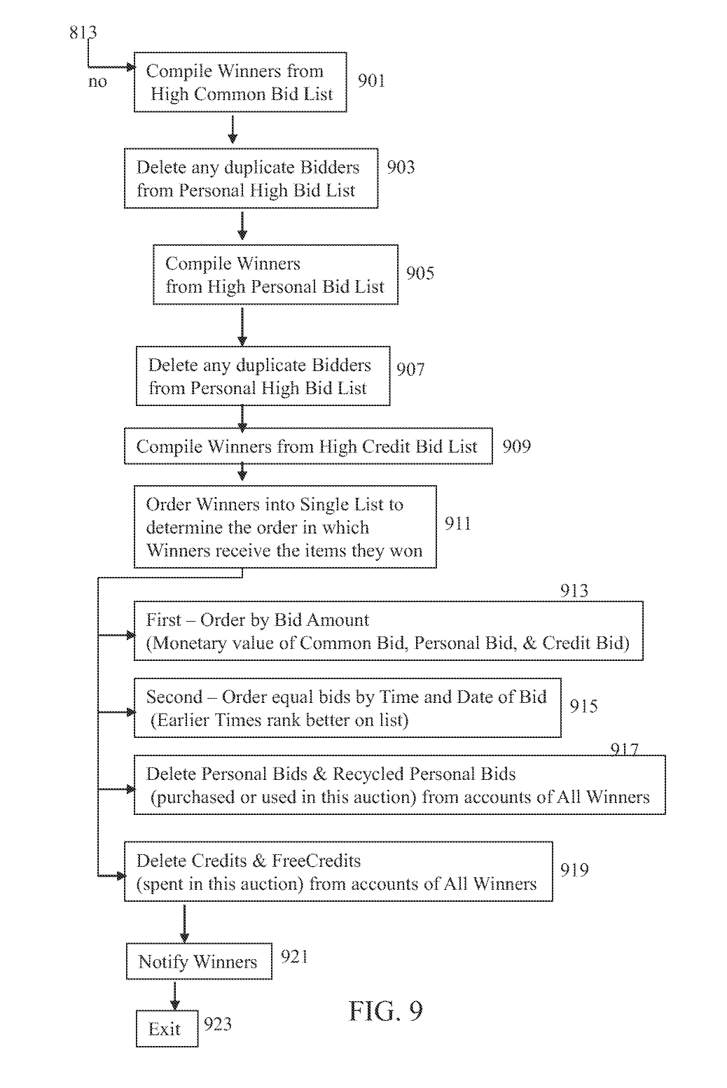

FIGS. 8 and 9 the logic flow of the process in determining the winner according to different auctions rules.

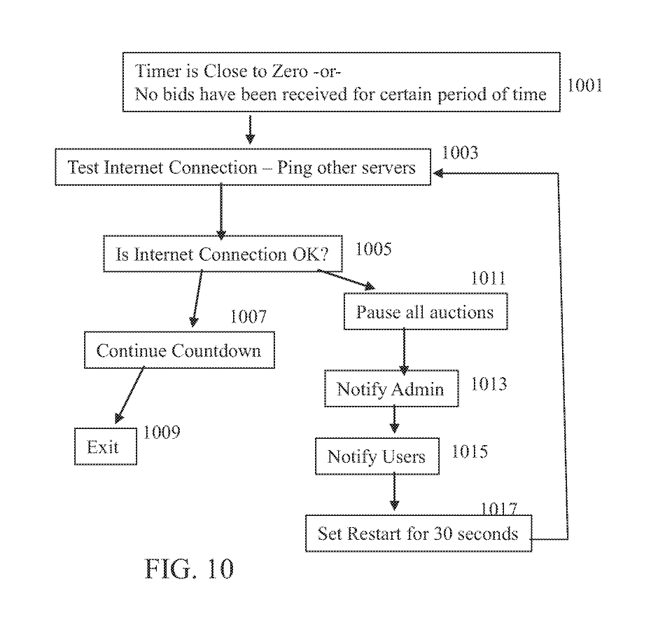

FIG. 10 illustrates the steps for test connections periodically to make sure unstable internet connections are remedied in terms of auction time counting down.

Alternate Method to generate High Bid List for Personal Bid and Credit Bid.—First Bid Only.

The rules for a particular auction could add only first bid, at a particular amount, to the High Personal Bid List and/or High Credit Bid List.

Example: If three participants have each purchased thirty bids, only the first bidder to have purchased thirty bids would be placed on the High Personal Bid List. The other two bidders would need to purchase more bids until they have purchased the first bid for a higher unique amount, such as thirty-one, or thirty-two.

The rules could also allow a bidder to be added to the High Personal Bid List or High Credit Bid List more than once.

With the normal method, each bidder could only be on either High Bid List just once, but in this case, they could be added to each list more than once by placing the first bid for more than one unique amount. The rules for each particular auction would define the limit as to how many times a bidder could be added on the list.
Example: If a participant places the first bid for thirty Personal Bids, then the first bid for thirty-one Personal Bids, they could be placed on the High Personal Bid List twice.

If a bidder has made the High Bid List by making the first bid for a certain amount, the rules would normally allow the bidder to continue to purchase bids without losing their position on the list. The bidder may wish to do this to make it easier for an attempt to purchase the first bid at a higher amount in case their lower High Bid has been outbid enough times for it to fall off the High Bid List.

### Group Bidding

Rules for certain auction could allow multiple bidders to cooperate to bid on behalf of a single person, or entity, such as a school or fire department.

Individual users could either bid directly or contribute credits, which would then be managed by an automatic bidder.

The other entity, such as a school, would not need to be a registered user. One user could simply register the name and city of the entity along with other relevant information.
Example: Users could cooperate to bid on an auction to win items for a particular school, such as computers, or playground equipment.

For some auctions, rules could also allow users to attempt to attract other users to bid on their own behalf.
Example: Students could attempt to convince other users to bid on their behalf for a computer or scholarship.
   Double-Bid Auction System. A single transaction places bids on two or more auctions at the same time.

When a bid is placed on one auction, a bid is also automatically placed in one or more other auctions.

For purposes of this explanation, these auctions will be named Double-Bid Auctions and Bonus Auctions. When a bid on one auction also causes a bid to be placed automatically on another auction, then these auctions are related to one another. Here, they will called ‘related’ or in a ‘System.’

System: All the Double-Bid Auctions and Bonus Auctions, which are related to one another.
In a System, all settings for each Double-Bid Auction and each Bonus Auction could be unique, including: the item for sale; the number of items sale; the number of items each participant could win; whether there is a reserve price; the reserve price; starting cost to bid; starting price; amount added to the common bid each time a bid is placed; amount added to the cost to bid each time a bid is placed; etc.
   To help keep the System simple for the participants to understand and easy to compare each auction, certain settings would normally be the same for all auctions in a System, such as: the amounts added to the cost to bid each time a bid is placed; and the amount added to the Common Bid each time a bid is placed.
      Also, the starting Cost to Bid for each Double-Bid Auction would normally be the same.
   To keep it fair for all participants, each Double-Bid Auction and Bonus Auction, which will be part of a system, will be announced before the start of any single auction in the system. In other words, no new auction would not be announced after any single auction started. Normally, each related auction would also begin at the same time (all Double-Bid Auctions and Bonus Auction(s).
      The starting Cost to Bid of the Bonus Auction would always be equal to or higher than each of the starting Costs to Bid for each Double-Bid Auction.

Double-Bid Auction: Each time a participant bids in a Double-Bid Auction, another bid will automatically be placed in each related Bonus Auction.
Normally, there would be more than one Double-Bid Auction in a System.
There could be one or more Double Bid Auctions.

Bonus Auction: Participants could also bid on the Bonus Auction directly. The Bonus Auction could continue even after all related Double-Bid Auctions have ended.
A Bonus Auction could have multiple items.
Normally, there would be just one Bonus Auctions in a System, but there could be more.
   If there are more than one Bonus Auctions in a System, then each Bonus Auction could have different items and/or different numbers of items.
Normally, the value of each item in the Bonus Auction would be higher than the value of any of the items in the Double-Bid Auctions, but the value could also be less than one or more of the Double-Bid Auctions.
Normally, Bonus Auctions would not award FreeCredits or Recycled Personal Bids for participants who do not win, but the opposite would be optional.
As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.
None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.
The claims as filed are intended to be as comprehensive as possible, and NO subject matter is intentionally relinquished, dedicated, or abandoned.

What is claimed is:

1. An electronic auction system, comprising:
an electronic server that runs an auction software and conducts auction process electronically wherein a chance-to-bid (Bid) in an auction is valued and placed for purchase, and an auction participant needs to purchase said Bid to place a bid in said auction, and winning of said auction is determined by an auction rule;
an electronic device electronically connected with said server, and installed with a database which keeps track of said participant's bidding history in an account of said participant; and
a display device electronically connected with said server, displaying information from said participant's account and said auction.

2. The electronic auction system of claim 1, wherein said chance-to-bid is valued differently at different stage of said auction.

3. The electronic auction system of claim 1, wherein said chance-to-bid is purchased in bulk at a discount.

4. The electronic auction system of claim 1, wherein the participant is provided free credits by the auction system

5. The electronic auction system of claim 1, wherein the participant's bidding history includes Personal Bid and Credit Bid, wherein Personal Bid is the total money cost in said auction for purchasing Bid in each round of bidding and Credit Bid is the total credits spent in said auction for purchasing Bid in each round of bidding.

6. The electronic auction system of claim 5, wherein said winning rule includes selecting a participant having highest Personal Bid and earliest bid time.

7. The electronic auction system of claim 5, wherein said winning rule includes selecting a participant having highest Credit Bid and earliest bid time.

8. The electronic auction system of claim 5, wherein said Personal Bid is reusable if the participant is not a winner.

9. The electronic auction system of claim 5, wherein said auction includes multiple items, and multiple auction rules are used for determination of winners for the items.

10. An electronic Pay-to-Bid auction system, comprising:
plurality of electronic server, each of said servers running a different version of an auction software and conducting a part of an auction process electronically wherein plurality of chance-to-bids (Bids) in an auction are valued and placed for purchase, and an auction participant needs to purchase one or more of said Bids to place a bid in said auction, and winning of said auction is determined by an auction rule;
an electronic device electronically connected with said servers, and installed with a database which keeps track of said participant's bidding history in an account of said participant; and
a display device electronically connected with said plurality of servers, displaying information from said participant's account and said auction.

11. The electronic Pay-to-Bid auction system of claim 10, wherein a participant who has placed a bid becomes a bidder, and High Bid List is built by only selecting the earliest bidder among bidders who have purchased similar number of bids.

12. The electronic Pay-to-Bid auction system of claim 10, wherein plurality of participants cooperate to bid on behalf of a single entity in one auction.

13. The electronic Pay-to-Bid auction system of claim 10, wherein plurality of related auctions, including first auction and other auctions, are conducted simultaneously, and a bid placed in first auction is automatically placed for other auctions.

14. The electronic Pay-to-Bid auction system of claim 13, wherein each of the plurality auctions has its own winning rule.

15. The electronic Pay-to-Bid auction system of claim 13, wherein plurality of items are auctioned in each individual auction, the auction rule allows one bidder to win more than one auctions.
